(19) United States
(12) Patent Application Publication
(10) Pub. No.: US 2026/0148410 A1
(43) Pub. Date: May 28, 2026

(54) METHOD AND SYSTEM FOR DETECTING AN OBJECT IN PHYSICAL ENVIRONMENTS

(71) Applicant: Siemens Industry Software Inc., Plano, TX (US)

(72) Inventors: Rafael Blumenfeld, Raanana (IL); Vladislav Murashkin, Ann Arbor, MI (US)

(21) Appl. No.: 19/121,527

(22) PCT Filed: Oct. 25, 2022
(86) PCT No.: PCT/US2022/047700

§ 371 Date: Apr. 16, 2025

(51) Int. Cl. G06T 7/73; G06T 5/40; G06T 15/06; G06T 19/20; G06V 10/25; G06V 10/56; G06V 20/64

(52) U.S. Cl. CPC G06T 7/73; G06T 5/40; G06T 15/06; G06T 19/20; G06V 10/25; G06V 10/56; G06V 20/64; G06T 2219/2016; G06V 2201/07

(57) ABSTRACT

A system and a method for detecting and locating an object in a physical environment. The method includes the following steps: Receiving a first image representing the physical environment, wherein the first image is a 3D point cloud image with location data for points in the point cloud image. Receiving a second image representing the physical environment, wherein the second image is a 2D pixel image of the physical environment. Detecting the object in one or more regions in the second image. For each region where the object has been detected in the second image, finding a corresponding region in the first image and providing, via an interface, the corresponding region in the first image as a location where the object has been detected.

### TECHNICAL FIELD

The present disclosure is directed, in general, to computer-aided design, visualization, and manufacturing (“CAD”) systems, product lifecycle management (“PLM”) systems, product data management (“PDM”) systems, production environment simulation, and similar systems, that manage data for products and other items (collectively, “Product Data Management” systems or PDM systems). More specifically, the disclosure is directed to digital representation of physical environments.

### BACKGROUND OF THE DISCLOSURE

Three-dimensional (“3D”) digital models of physical environments are used for various tasks and purposes. For instance, usages of a 3D representation of a factory or of manufacturing assets can include, but are not limited by, manufacturing process analysis, manufacturing process simulation, equipment collision checks, and virtual commissioning.

As used herein the terms manufacturing assets and devices denote any resource, machinery, part and/or any other object, like machines, present in the manufacturing lines, or more generally speaking, in a physical environment. For instance, examples of devices comprised in a physical or real manufacturing environment include, but are not limited by, industrial robots and their tools, transportation assets like e.g. conveyors, turn tables, safety assets like e.g. fences, gates, automation assets like e.g. clamps, grippers, fixtures that grasp parts and more.

In such physical environments, one problematic remains the detection and location of assets. Indeed, it may happen that a device has been moved from one location to another in a factory, or that new equipment has been installed. These changes, notably with respect to the location or new installation of equipment, have to be entered in the IT system of the factory. The easiest way to do it is having an operator physically touring the factory for identifying the assets, determining their current location, and updating with corresponding data a database of the IT system. However, such a manual identification is time consuming and not efficient.

Nowadays, digital solutions facilitate such tasks. For instance, scanners can automatically scan a current layout of a physical environment, e.g. a production line of a factory, and automatically identify different assets using known in the art image processing techniques. In particular, the point clouds, i.e. the digital representations of a physical object or environment by a set of data points in space, became more and more relevant for applications in the industrial world. For example, 3D scanning cameras can create point clouds by determining a large number of points on surfaces of a physical environment, and such point cloud technologies can then be used in complex analyses and designs of various factories, automotive manufacturing lines, microcircuit fabrication centers, or any other industrial setting. Thus, the acquisition of point clouds with 3D scanners enables to rapidly get a 3D image of a scene, e.g. of a production line of a shop floor, said 3D image comprising location information of each acquired point with respect to the surrounding space. This ability of the point cloud technology to rapidly provide a current and correct representation of an object of interest is of great interest for decision taking and task planning since it shows the very latest and exact status of the shop floor. Additionally, from said point cloud, it is then possible to reconstruct an image, e.g. a 2D or 3D image of said environment or object, using meshing techniques. The latter are configured for creating 3D meshes from the points of the cloud, converting the point cloud to 3D surfaces. Nowadays, meshing tools to automatically create such meshes or even directly a CAD model from the entire point cloud scene are available.

Therefore, point cloud data can be used for detecting and locating objects in a physical environment like a factory. However, for complex factories, processing point clouds is a heavy and slow process, especially in the case of high-resolution scans that produce point clouds with millions of points. Additionally, the techniques based on the point cloud may generate many false positives, which further requires manual analysis for filtering the results.

Therefore, improved techniques for detecting and locating an object in a physical 3D environment are desirable.

### SUMMARY OF THE DISCLOSURE

Various disclosed embodiments include methods, systems, and computer readable mediums for detecting and locating an object in a physical environment. A method includes: i) receiving or acquiring a first image representing said physical environment, wherein said first image is a 3D point cloud image comprising location data for points in the point cloud image, ii) receiving or acquiring a second image representing said physical environment, wherein said second image is a 2D pixel image of said physical environment, iii) detecting said object in one or several regions in the second image, iv) for each region where said object has been detected in the second image, finding a corresponding region in the first image, and, v) providing, via an interface, said corresponding region in the first image as a location where said object has been detected, and optionally, extracting, from the first image, a position of the object from location data associated to at least one point of said corresponding region in the first image.

A computing system comprising a processor and an accessible memory or database is also disclosed, wherein the data processing system is configured to carry out the previously described method.

The present invention proposes also a non-transitory computer-readable medium encoded with executable instructions that, when executed, cause one or more data processing systems to perform the previously described method.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a computing system in which an embodiment can be implemented.

FIG. 2 illustrates a flowchart describing a preferred embodiment of a method for detecting and locating an object in a physical environment according to the invention.

FIG. 3A schematically illustrates a first image according to the invention.

FIG. 3B schematically illustrates a second image according to the invention.

FIG. 3C schematically illustrates a third image according to the invention.

FIG. 4 illustrates a flowchart describing a preferred first embodiment of a detection of an object according to the invention.

FIG. 5 illustrates a flowchart describing a preferred second embodiment of a detection of an object according to the invention.

FIG. 6 illustrates an example of clustering into dominant colors for an object.

FIG. 7 illustrates schematically a detection of an object in a second image according to the invention.

FIG. 8 illustrates a conversion of a panoramic pixel image into a cube map.

### DETAILED DESCRIPTION

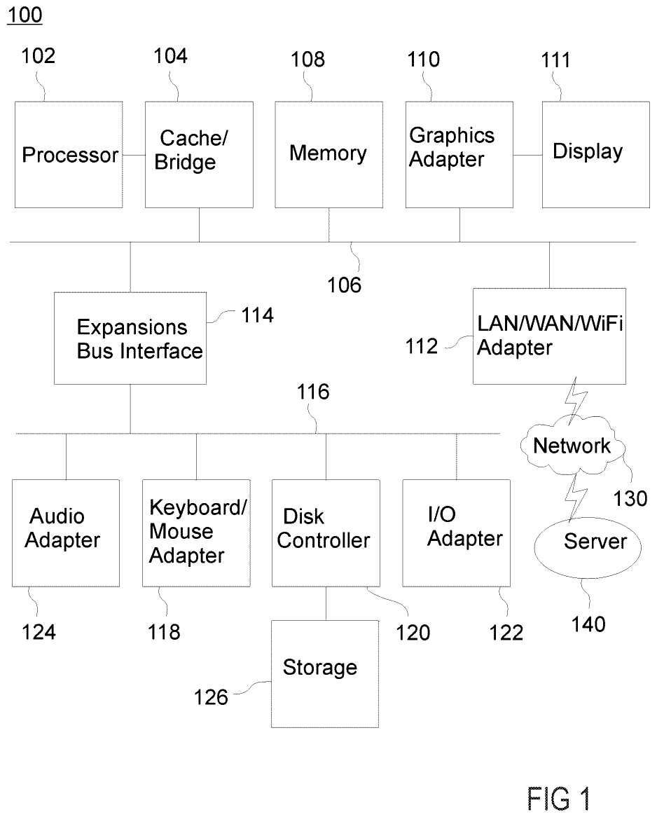

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Nowadays, 3D mapping of a physical environment, e.g. an industrial indoor manufacturing line, can be performed by laser scanners, e.g. a three-axis laser scanner, wherein, by scanning said physical environment, the laser scanner generates a cloud of points wherein each point is characterized by coordinates defined in a frame of reference, usually associated to the position of the laser scanner. Additionally, the laser scanner may integrate a camera, e.g. a panoramic camera, for acquiring, notably simultaneously to the acquisition of the point cloud, a pixel image, e.g. a panoramic image, of the physical environment. In other words, from the same point of view which corresponds to the position of the laser scanner in said physical environment, two images might be acquired, namely a first image that is a point cloud representing said physical environment, and a second image that is a pixel image of said physical environment, preferentially an equirectangular panoramic image of said physical environment. Preferentially, the first and second image are acquired simultaneously. The present invention proposes to use said two images for improving the detection and location of objects, e.g. equipment, in said physical environment. While preferably the first and second images according to the invention might be taken by a single device incorporating both a laser scanner and a camera, and therefore from the same point of view, it is also envisaged, within the present invention, to acquire the first image from a first viewpoint and the second image from a second viewpoint different from the first viewpoint, and then to orient the point cloud according to known in the art techniques for matching the viewpoint of the second image. What remains essential is that the first and second images are images of the same physical environment, i.e. images of a same real scene.

FIG. 1 illustrates a block diagram of a computing system 100, e.g. a data processing system, in which an embodiment can be implemented, for example as a PDM system particularly configured by software or otherwise to perform the processes as described herein, and in particular as each one of a plurality of interconnected and communicating systems as described herein. The computing system 100 illustrated can include a processor 102 connected to a level two cache/bridge 104, which is connected in turn to a local system bus 106. Local system bus 106 may be, for example, a peripheral component interconnect (PCI) architecture bus. Also connected to local system bus in the illustrated example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but are not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Optionally, an imaging device comprising a laser scanner and a camera, wherein said laser scanner and said camera are configured for, preferably simultaneously, imaging a same scene of a physical environment, is part of the computing system 100 or connected to the latter for providing it with said first and second image of the physical environment. At the end, said first image and said second image might be displayed, successively or simultaneously, on the display 111.

Those of ordinary skill in the art will appreciate that the hardware illustrated in FIG. 1 may vary for particular implementations. For example, other peripheral devices, such as an optical disk drive and the like, also may be used in addition or in place of the hardware illustrated. The illustrated example is provided for the purpose of explanation only and is not meant to imply architectural limitations with respect to the present disclosure.

A computing system 100 in accordance with an embodiment of the present disclosure can include an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of computing system 100), which can be any public or private data processing system network or combination of networks, as known to those of skill in the art, including the Internet. The computing system 100 can communicate over network 130 with server system 140, which is also not part of the computing system 100, but can be implemented, for example, as a separate data processing system.

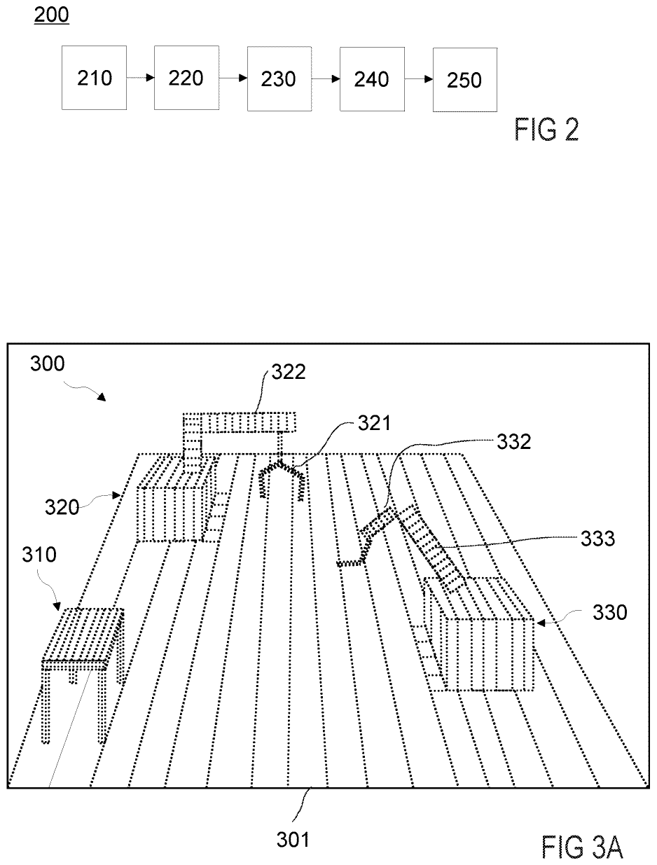

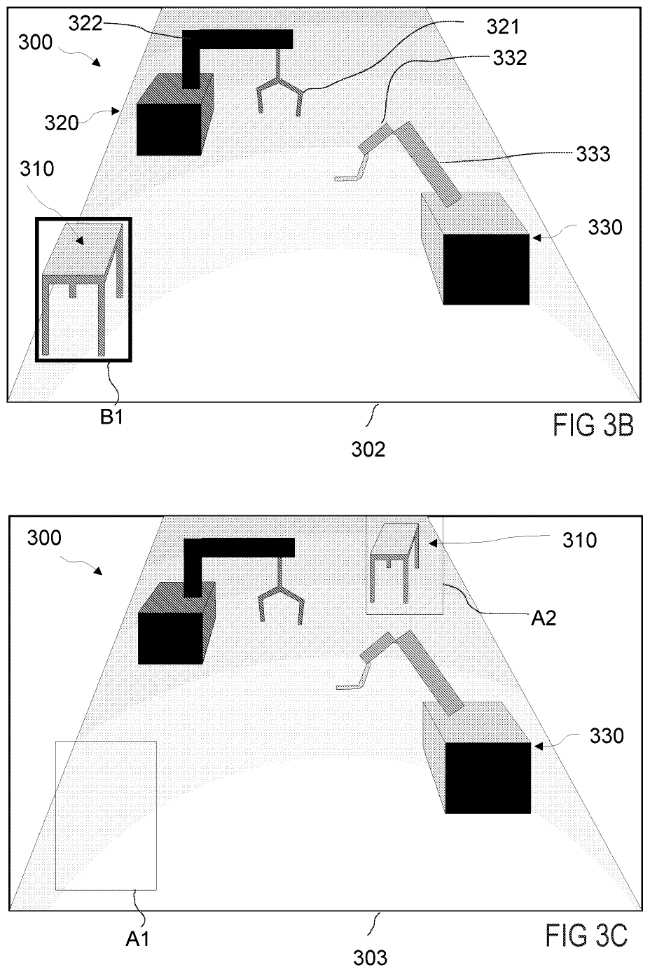

FIG. 2 illustrates a flowchart of a method for detecting and locating an object in a physical environment. The method will be explained in details hereafter in connection with FIG. 3A and FIG. 3B which present respectively a first image 301 and a second image 302 of a schematic and non-limiting physical environment 300 according to the invention. The first image 301 is point cloud image of said physical environment. The second image 302 is a pixel image of said physical environment 300. The first and second image might be acquired simultaneously or shortly one after the other (e.g. the time separating the end of the acquisition of one of said images from the start of the acquisition of the other image is smaller than 30 seconds). The physical environment 300 is for instance a manufacturing line, or a packaging line, or any other environment comprising one or several objects, wherein at least one object has to be located, and therefore also detected. Said object might be some furniture, like a chair or a table 310, or equipment of a line, like a robot 320, 330, or a specific part or tool of a robot, like a jaw or a wrench 321, or a robot arm 322, 332, 333, or any other object or equipment that is part of said physical environment 300. For the purpose of illustration of the method according to the invention, the table 310 will be the object to be detected and located.

At step 210, the computing system 100 according to the invention acquires or receives, notably from a 3D laser scanner, said first image 301 that is a point cloud of said physical environment 300. Said first image 301 can be acquired by a laser scanner that is part of the computing system according to the invention, or connected to it, said laser scanner being configured for scanning the physical environment 300, e.g. a production line of a manufacture, and collecting, from said scanning, point cloud data, i.e. one or several sets of data points in space, wherein each point position is characterized by a set of position coordinates. Said points represent the external surface of objects of the physical environment, and the laser scanner records thus within said point cloud data information about the position within said space of a multitude of points belonging to the external surfaces of objects surrounding the laser scanner, and can therefore reconstruct, from said point cloud data, 2D or 3D images of its surrounding physical environment for which the points have been collected. Of course, the present invention is not limited to this specific type of scanners, and might receive or acquire a first image from any other kind of scanner configured for outputting such point cloud data when acquiring a point cloud image of said physical environment. The computing system 100 may also acquire or receive said first image 301 from another computing system, from a database, from a memory, e.g. a memory stick.

At step 220, the computing system 100 receives or acquires said second image 302 of said physical environment 300. Said second image 302 might be acquired by a camera system of the laser scanner. Preferentially, the first and second image according to the invention are acquired by using a same viewpoint with respect to said physical environment. Preferentially, said second image 302 is a panoramic image of said physical environment 300. It can be for instance a 360° panoramic image of said physical environment 300. If the first image and the second image do not share a same viewpoint, then the computing system according to the invention might be configured for automatically determining, within a 3D space defined by the point cloud, a viewpoint that matches the viewpoint used for acquiring the second image 302, and optionally for orienting the first image accordingly, e.g. automatically orienting the cloud of points in order to enable displaying said physical environment from said same viewpoint, so that the first image 301 and the second image 302 can represent a same scene, e.g. when displayed simultaneously or successively on a display system. The computing system 100 may also acquire or receive said second image 302 from another computing system, from a database, from a memory, e.g. a memory stick, or from another camera system.

At step 230, the computing system 100 is configured for detecting 230 said object 310 in one or several regions in the second image 302. In other words, the present invention proposes to detect the object in the pixel image. For said detection, the cloud point image (first image) is thus not used. This provides the advantage of decreasing the required resources (e.g. amount of memory used for this task versus time) for performing this task. Indeed, as already explained, using a point cloud image for object detection can be very resource consuming, especially in high resolution scans. According to the present invention, different techniques might be used for detecting the object 310 in the second image 302.

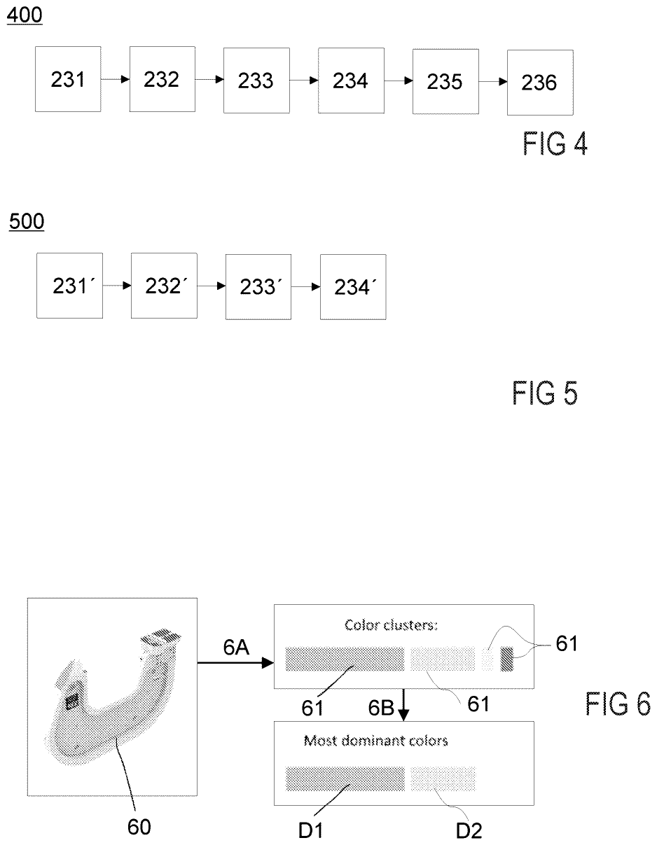

According to a first embodiment 400, a color profile associated to the object 310 can be used for detecting said object. In this case, the detection according to the invention comprises the following steps illustrated by FIG. 4:

At step 231, the computing system 100 is configured for finding, in said second image 302, pixels whose color value falls within a range of color values defined in function of a cluster of color values that represents a dominant color of the object 310. According to the present invention, said object 310 might be associated to one or several clusters of color values, wherein each cluster represents the most, or one of the most, dominant colors of said object 310, i.e. each object that has to be detected and located might be associated to a subset of colors that represents the dominant colors of said object, said subset of colors being then used for detecting said object in pixel images. For this purpose, the computing system 100 comprises in particular a database or library configured for storing for each of one or several objects which might be part of said physical environment 300, a color profile, wherein the color profile of an object defines one or several ranges of color values, wherein each range of color values represents one of the dominant colors of the object. Preferentially, RGB values are used for the color values of an object.

Preferentially, for each of said relevant object 310, 61, for which one or several ranges of color values have been determined by the computing system, the latter also calculates a reference histogram that is a color histogram of the pixels of the relevant object 310, i.e. of the image of the relevant object 310, 61. Preferentially, for each relevant object, such a reference histogram is saved in said database or library.

Therefore, detecting the object 310 using the color profile technique requires to construct, beforehand, a database or library comprising or storing, for each object that can be relevant for object detection and location according to the invention, a color profile of the dominant colors of said object, storing for instance for each object, its dominant color values. This method takes advantage of the fact that industrial equipment is typically characterized by specific coloring per equipment type/vendor, allowing for a fast identification based on a color profile. In particular, since the number of different types of assets/objects in physical environment, e.g. in an industrial or manufacturing environment, is limited, a color profile can be easily captured for each type of assets/objects, notably for important types of equipment of the physical environment, such as robots, cranes, etc., and then stored in said library or database.

For populating said library or database with color profiles for each relevant object (i.e. each object that might be relevant for object detection and location according to the present invention) of said physical environment, one or several images of said relevant object are analyzed and/or processed by the computing system 100, wherein said analysis and/or processing comprises clustering pixel colors belonging to said object into groups, using notably a k-means algorithm. This clustering process is schematically illustrated in FIG. 6 for a relevant object 60, wherein the clustering 6A results in four different dominant colors represented by four different clusters of pixel color values. The k-means clustering technique enables for instance to create k groups (or clusters) of pixel colors (e.g. 4 groups of pixel colors according to FIG. 6), wherein each group is characterized by a mean color value which represents a dominant color, and wherein each pixel of the object is classified, in function of its color, into the group which is characterized by the mean color value that is the nearest to its color value (notably in terms of RGB value). In FIG. 6, the colors of the bars 61 represent each a mean color value (i.e. dominant color) of the relevant object, and the size (length) of the color bars 61 is proportional to the number of pixels of said relevant object characterized by a color value that is “within a range” of the mean color value defined for the concerned group (or bar), i.e. that is the nearest (e.g. in term of difference in RGB values) to the mean color value defined for said concerned group (or bar). Preferentially, a threshold is used for automatically discarding pixel groups comprising a low number (e.g. less than 20% or 10%) of pixels with respect to the total number of pixels of said relevant object, keeping therefore only the “most” dominant colors (i.e. the remaining clusters after said discarding step). For instance, in FIG. 6, groups that comprise less than 10% of the pixels of the relevant object are automatically discarded 6B, resulting in this particular case in two most dominant colors D1 and D2. Thus, for each relevant object, one or several clusters of pixel color values might be determined. For a same object, each cluster of pixel color values represents a different dominant color of the concerned object. Dominant colors represented by a low number of pixels compared to the total number of pixels of the object might be discarded to keep only the most dominant colors. Hereafter, no distinction will be done between most dominant colors and dominant colors, the wording “dominant colors” encompassing also “most dominant colors”. The goal of the detection is then to find, in the second image, pixels that belong to one of the clusters (or to the cluster if there is only one dominant color) that have (or has if only one dominant color) been determined for the object that has to be detected and/or located. For this purpose, a range of color values is defined for each color cluster that represents a dominant color of the object. Therefore, one or several ranges of color values might be defined in the color profile of an object, and then used for determining whether pixels of the second image belong or not to said color profile. For instance, a range of color values might be defined in function of a mean color value obtained for the cluster. Alternatively, a range of color values might be defined in function of a lowest and highest color values of the cluster (i.e. from the darkest and lightest color values of the cluster). Therefore, from the cluster of color values representing a dominant color, the skilled person might use different ways of defining said ranges of values. For instance, let's consider a color value defined by an RGB triplet (R, G, B) with R, G, B having values between 0-255. Let's consider also that a dominant color of a relevant object is “red”, and that the mean color value for said dominant color is the RGB value (160, 25,25). According to a first embodiment, the range of colors values for a given dominant color might comprise all color values (Ri, Gi, Bi), wherein Ri_min<Ri<Ri_max, Gi_min<Gi<Gi_max, and Bi_min<Bi<Bi_max, wherein K_min and K_max represents respectively the lowest color value and the highest color value for the considered color K, with K=Ri, Bi, Gi, in the cluster represented by said dominant color. For instance, in the case of a red dominant color, we might have 110<Ri<200, 0<Gi<50, and 0<Bi<25. In this case, the range of colors values might be considered, or might be seen, as a bounding box surrounding, or enclosing at least partially, the cluster of color values representing the dominant color. Alternatively, if the mean color value for said dominant color is the RGB value (160, 25,25), then said range might be defined in function of said mean color value, by defining for instance intervals in function of each of the RGB values R1=160, G1=25, and B1=25. More generally speaking, if a mean color value is defined by an RGB triplet (R1,G1,B1) with R1, G1, B1 having values between 0-255, then said range might be defined as ([R1-d1 if R1-d1 is positive otherwise 0, R1+d2 if smaller than 255 otherwise 255], [G1-d3 if G1-d3 positive otherwise 0, G1+d4 if smaller than 255 otherwise 255], [B1-d5 if B1-d5 positive otherwise 0, B1+d6 if smaller than 255 otherwise 255]), wherein for instance d1, ..., d6 are integers comprised between 5 and 10. In particular, d 1=d2=...=d6. Preferentially, the number of dominant colors for each object in the database or library is at most two, e.g. the two clusters comprising the most pixels. Alternatively, additional (i.e. more than two) dominant colors might be taken into consideration. Keeping a low number ensures a fast and efficient detection of the object in the second image. For instance, the computing system can be configured for selecting, among the mean color values, only those that are associated to a group of pixels comprising a number of pixels, which, when compared to the total number of pixels of the relevant object, is higher than a predefined ratio, the mean color values of the selected groups becoming then one of the dominant colors for which range of colors values are then defined and used for detection purposes. Whatever the technique used for selecting or determining a set of dominant colors for a relevant object, the dominant colors are and remain a subset of the color values/colors of said relevant object, said subset being configured for enabling an identification or detection of said relevant object in pixel images of said physical environment. At the end of said analysis or processing of said one or several images for each relevant object, the computing system is configured for saving in said library or database the range of color values that has been determined or defined for each of the dominant colors of the relevant object.

Preferentially, said range of color values might be defined automatically during the clustering process for each mean color value or each cluster, by determining for instance for each cluster the smallest and highest color values among the color values of the pixels that have been grouped in said cluster, said range providing then for instance one or several color value intervals extending from said smallest color value to said highest color value.

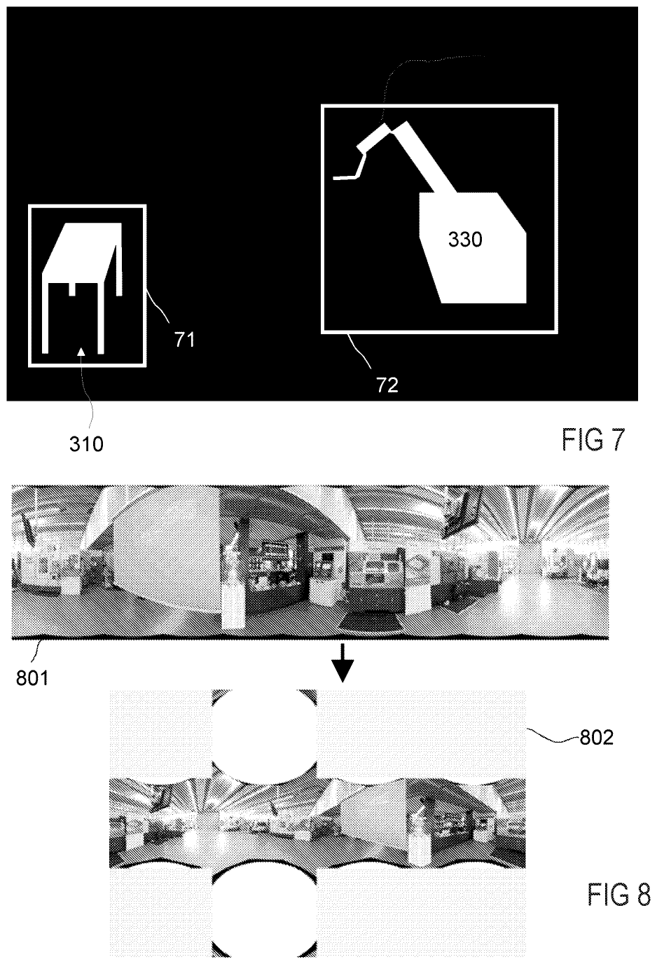

During the detection process, the computing system 100 automatically £ determines, for each pixel of the second image, whether the color value of said pixel falls within at least one of the ranges of colors values defined for the dominant colors of the object to be detected. If yes, the pixel is considered by the system as belonging to the object to be detected, otherwise, the pixel is discarded or ignored. Preferentially, the computing system leaves in the second image only pixels that have been determined as belonging to the object (i.e. to one of said ranges), the other pixels being removed from said second image. Optionally, and notably after said removal of pixels considered as not belonging to the object to be detected, the computing system may run a morphological transformation of erosion followed by dilation in order to remove noise from said second image. Preferentially, the computing system 100 is then configured for converting the second image (e.g. the remaining pixels) into a binary image. In particular, at step 232, the computing system can for instance convert the detected pixels, i.e. the pixels considered as belonging to the objected to be detected, to a white color and all other pixels of the second image 302 to a black color. The result of such a conversion is shown in FIG. 7, wherein only the pixels of the table 310 and robot 330 which had colors falling within the range of the dominant colors of the object to be detected remain in the image.

At step 233, the computing system 100 is configured for identifying one or several shapes formed by one or several groups/clusters of the detected pixels. Optionally, at step 234, the computing system is configured for surrounding each identified shape by a bounding box 71, 72 as shown in FIG. 7.

In order to remove false positive, the computing system 100 is configured, at step 235, for comparing, for each identified shape, a color histogram of the pixels of the second image 302 that belong to said identified shape to said reference histogram, i.e. the color histogram of the pixels of the object 310 for which said range(s) of color values has (have) been determined, and if the comparison results in a color histogram difference that is above a predefined threshold (i.e. if the reference histogram and the color histogram of the considered shape differ above said predefined threshold), then the computing system is configured for discarding the identified shape, otherwise the computing system is configured for identifying, at step 236, and/or memorizing the region in the second image 302 where said shape, corresponding to the object 310 to be detected and located, has been identified. In particular, for identifying said region, the computing system might be configured for surrounding the identified shape by a bounding box 71 if not already previously implemented. For instance, in the case illustrated by FIG. 7, the shape surrounded by the bounding box 72 would be discarded, while the shape surrounded by the bounding box 71 would be identified as the region, within the second image 302, where the object has been detected. At the end, and in particular, the identified region can be memorized in the computing system for further processing.

Therefore, using color profiles, regions, in the second image, where said object to be detected and located is present might be identified or detected. Of course, other techniques might be used for detecting and locating an object in the second image. One of said other techniques, illustrated by FIG. 5 together with FIG. 3C, will be explained in more details below, and enables to detect an object that is missing or newly present at some place in said physical environment, in particular it enables to detect a presence or absence of an object in the second image.

According to this second preferred embodiment 500, the computing system 100 is configured for receiving or acquiring, at step 231′, a third image 303 and optionally a fourth image, wherein the third image 303 is a 2D pixel image of said physical environment 300, but acquired at a different time T and preferentially according to a same point of view as the second image 302. The fourth image is for instance a point cloud image of said physical environment acquired at said different time T compared to the first point cloud image. Preferentially, the second and third images are equirectangular panoramic images. In other words, the computing system 100 is configured for receiving pictures of said physical environment, wherein said pictures are acquired according to a same viewpoint but at different times. This enables a temporal comparison of images (representing the same physical environment) acquired at different times in order to identify changes occurring in said physical environment, wherein said changes may represent a new presence or absence of one or several objects in the physical environment.

At step 232′, the computing system is configured for comparing the second image 302 with the third image 303 in order to identify one or several areas A1, A2, within the second image 302 or third image 303, wherein said second image 302 and said third image 303 differ. Said comparison enables thus to identify areas in temporally successive pixel images of said physical environment that are significantly different between the successive acquisitions, wherein said comparison might be based on computer vision techniques for object detection as described for instance in the paper of Neelam Dwivedi et al. (“An Approach for Unattended Object Detection through Contour Formation using Background Subtraction, Procedia Computer Science (171): p. 1979-1988 (2020)). Before starting comparison step 232′, the method according to the invention may comprise additional steps for processing the second and third images. Such an image processing technique is illustrated by FIG. 8. In this example, the second and third images are equirectangular panoramic images, and the computing system 100 is configured for converting said second and third images to a cube map to minimize distortion. In FIG. 8, the equirectangular panoramic image of the physical environment corresponds to image 801 which is then converted into the cube map 802. Of course, other image processing techniques may apply before the comparison step 232′ for facilitating said comparison between the first and second images.

At step 233′, the computing system is configured for discarding identified areas whose size is smaller than a predefined area threshold (defined for instance according to a number of pixels), and, for each identified area whose size is greater than said predefined area threshold, it is further configured, at step 234′, for identifying and/or memorizing the region, in the second image 302, where said area, which corresponds to a missing or newly present object to be detected and located, has been identified. In order to identify said region in the second image 302, the computing system 100 might for instance surround the concerned area by a bounding box B1 which can be easily detected by a user if said second image is displayed. For instance, the computing system might be configured for simultaneously displaying, for instance side by side, the second and third image, wherein each area for which a change has been detected (or identified) is highlighted, e.g. in both images, by a bounding box for easy visualization by a user. If needed, the computing system might be configured for automatically orienting the first and second image to a same viewpoint with respect to an area that has been detected or identified. Preferentially, only regions corresponding to a new presence of an object are identified in the second image 302. Thanks to this discarding step, small changes between temporally successive images are ignored by the computing system, decreasing false positive results.

After the detection step 230, the computing system 100 is configured for finding, at step 240, and for each region in which said object 310, e.g. missing object or newly present object, has been detected in the second image, a corresponding region in the first image 301. For this purpose, the computing system 100 might be configured for automatically determining, for each pixel of the second image 302, a corresponding 3D coordinate in the point cloud image. In particular, finding a corresponding region might be implemented by the computing system by projecting the second image 302 onto a sphere, using for instance an equirectangular projection, wherein the center of said sphere corresponds to the view point from which the second image 302 has been acquired, then identifying or characterizing each pixel of the second image 302 by two angles corresponding to spherical coordinates of said pixel with respect to a spherical coordinate system centered onto the sphere center, and, from the same viewpoint in the 3D point cloud, casting a ray according to the identified spherical coordinates until intersecting a (tessellated) surface defined by, or reconstructed from, said point cloud. The coordinates of the intersection of said ray with said surface are then said corresponding 3D coordinate of the pixel in the point cloud with respect to said spherical coordinate system. In addition or alternatively, the computing system might be configured for automatically matching features and/or objects of said physical environment 300 that are present in both the first image 301 and second image 302 for determining, in the first image, positions of pixels of the second image, so that said corresponding region be found. If needed, the computing system might be configured for automatically matching a scale used for representing the physical environment 300 in the first image 301 to a scale used for representing said physical environment 300 in the second image 302 so that objects present in said physical environment 300 be characterized by a same magnification in the first and second image. Of course, other known in the art techniques might be used for determining, for each pixel of the second image 302, a corresponding 3D coordinate in the point cloud image.

Then, at step 250, the computing system 100 is configured for providing, via an interface, said corresponding region in the first image 301 as a location where said object 310 has been detected, and optionally, for extracting, from the first image 301, a position of the object from location data associated to at least one point of said corresponding region in the first image 301. In particular, said at least one point of the corresponding region might be the center of a (said) bounding box B1, 71 used, in the second image 302, for identifying the region where the shape of the object or the presence/absence of the object has been identified, said bounding box being configured for surrounding the identified shape/area in said second image. Preferentially, the point cloud of the first image might be presented to a user, e.g. via a display, oriented according to a same viewpoint as the second image, wherein the corresponding region comprising the detected missing or present object is surrounded by a bounding box.

Advantageously, the detection and location of an object according to the present invention might be used for automatically triggering an action. For instance, based on said detection and location, the computing system 100 according to the invention may automatically update a database with position information of the detected object, and/or may generate an alert signal if an object is absent from the physical environment while it was previously present, or may automatically display the first image and highlight the corresponding region in the first image, so that a user can easily identify, within the point cloud, where the object has been found or was missing.

Advantageously, the first preferred embodiment 400 for detecting an object enables to drastically reduce the number of match candidates when searching for an object in a physical environment by using color profiles of objects/equipment for identifying relevant areas in the second image. This method allows for a fast identification of relevant object, notably in an industrial setting wherein object might be considered as color encoded (i.e. one set of dominant colors for robots, another set of dominant colors for furniture, etc.), and a minimization of number of false positive matches.

The second preferred embodiment 500 for the detection proposes to analyze pixel images of the physical environment from two scans or pixel image acquisitions of a same scene but taken at a different time. A same scene of the physical environment is thus observed at two different times, which enables an efficient and quick detection of missing or newly installed objects. Once changes are detected in such a scene, they can be presented to a user along with a corresponding area or region in the point cloud of the first image. In order to detect said changes, computer vision techniques, such as color profile or histogram, shape detection, contour detection and others, can be used. Preferentially, the computing system extracts a set of metrics (e.g. shape of an object, and/or color profile, and/or size, and/or location, and/or any other metrics that can be obtained from the point cloud data) from the second image that are extracted from the point cloud data (notably the position of the points), and that can be used to identify and locate, within the first image, high level changes between point cloud scans, such as equipment changing position or addition/removal of equipment. Using said metrics enables to quickly and efficiently extract from the second image information characterizing the object that needs to be detected/located instead of extracting such information from the point cloud. The advantage is a much faster detection of objects compared to methods based on distance calculation or 3D mesh generation. Once changes are identified in one or several areas of the second image 302 or third image 303, corresponding region(s) “of interest” can be identified on top of the point cloud (corresponding to the first or fourth image), enabling thus a user to quickly assess a potential change in the physical environment when displaying the point cloud and pointing out said corresponding region(s). This eliminates notably the need to compare all the points in a point cloud, by focusing instead on said corresponding regions.

The method according to the invention provides thus an interactive identification of high-level changes in industrial environment for decision making and use of computer vision techniques to detect changes between scans. Pixel panoramic images are preferentially used for identifying changes, notably between scans, instead of 3D data. The use of pixel images for detecting objects enables implementing a “rough” analysis for detecting relevant image areas and discarding small changes that are irrelevant, instead of a time-consuming precise point cloud analysis when working with point cloud data. Consequently, relevant regions in the point cloud can be rapidly identified from relevant areas detected in the pixel image(s), which enables a very fast identification of (missing/present) objects in the point cloud image, while decreasing the number of false positives. Taking into account that there are over a thousand panoramic images and laser scans covering all areas in a typical automotive factory, then the presently claimed method allows for a very fast identification of objects with small number of false positives compared to other computational heavy methods. This helps for instance operators to detect suspicious changes in areas where no changes should have been made, or make sure that the changes such as equipment addition or removal did in fact take place.

In embodiments, the term “receiving”, as used herein, can include retrieving from storage, receiving from another device or process, receiving via an interaction with a user or otherwise.

Those skilled in the art will recognize that, for simplicity and clarity, the full structure and operation of all data processing systems suitable for use with the present disclosure is not being illustrated or described herein. Instead, only so much of a data processing system as is unique to the present disclosure or necessary for an understanding of the present disclosure is illustrated and described. The remainder of the construction and operation of data processing system 100 may conform to any of the various current implementations and practices known in the art.

It is important to note that while the disclosure includes a description in the context of a fully functional system, those skilled in the art will appreciate that at least portions of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims.

1-15. (canceled)

16. A method for detecting and locating an object in a physical environment, the method comprising:
by a computing system:
receiving a first image representing the physical environment, the first image being a 3D point cloud image with location data for points in the point cloud image;
receiving a second image representing the physical environment, the second image being a 2D pixel image of the physical environment;
detecting the object in one or more regions in the second image;
for each region where the object has been detected in the second image, finding a corresponding region in the first image; and
providing, via an interface, the corresponding region in the first image as a location where the object has been detected.

17. The method according to claim 16, wherein the providing step comprises extracting, from the first image, a position of the object from location data associated with at least one point of the corresponding region in the first image.

18. The method according to claim 16, wherein finding the corresponding region comprises automatically orienting the point cloud to a same viewpoint as a viewpoint used for acquiring the second image.

19. The method according to claim 16, wherein finding the corresponding region comprises automatically determining, for each pixel of the second image, a corresponding 3D coordinate in the point cloud image.

20. The method according to claim 16, wherein finding the corresponding region comprises projecting the second image onto a sphere, wherein a center of the sphere corresponds to a given viewpoint from which the second image has been acquired, identifying each pixel of the second image by two angles corresponding to spherical coordinates of the pixel with respect to a spherical coordinate system centered on the center of the sphere, and, from the given viewpoint in the 3D point cloud, casting a ray according to the identified spherical coordinates until a surface is intersected that is defined by, or reconstructed from, the point cloud.

21. The method according to claim 16, which comprises automatically matching a scale used for representing the physical environment in the first image to a scale used for representing the physical environment in the second image.

22. The method according to claim 16, wherein the detecting step comprises:
finding, in the second image, pixels whose color value falls within a range of color values defined as a function of a cluster of color values that represents a dominant color of the object;
identifying one or more shapes formed by one or more groups of the pixels found in the finding step;
for each identified shape, comparing a color histogram of the pixels of the second image that belong to the identified shape to a color histogram of the pixels of the object for which the range of color values has been determined; and
if the comparing step results in a color histogram difference that lies above a predefined threshold, discarding the identified shape, and otherwise at least one of identifying or memorizing the region in the second image where the shape that corresponds to the object to be detected and located has been identified.

23. The method according to claim 22, wherein the at least one point of the corresponding region corresponds to a center of a bounding box in the second image that is used for identifying the region where the shape has been identified, the bounding box being configured for surrounding the identified shape in the second image.

24. The method according to claim 16, which comprises configuring the detecting step to detect an object that is missing or newly present at some place in the physical environment, the detecting step comprising:
receiving a third image that is a 2D pixel image of the physical environment acquired according to a same point of view as the second image, but at a different time T;
comparing the second image with the third image in order to identify one or more areas wherein the second image and the third image differ;
discarding areas whose size is smaller than a predefined area threshold, and, for each area whose size is greater than the predefined area threshold, identifying and/or memorizing the region in the second image where the area, which corresponds to the missing or newly present object to be detected and located, has been identified.

25. A computing system, comprising:
a processor; and
an accessible memory, the computing system being configured to:
acquire or receive a first image representing a physical environment, the first image being a 3D point cloud image with location data for points in the point cloud image;
acquire or receive a second image representing the physical environment, the second image being a 2D pixel image of the physical environment;
detect the object in one or more regions in the second image;
for each region where the object has been detected in the second image, find a corresponding region in the first image; and
provide, via an interface, the corresponding region in the first image as a location where the object has been detected.

26. The computing system according to claim 25, wherein, for detecting the object in one or more regions in the second image, the computing system is configured to:
find, in the second image, pixels whose color value falls within a range of colors values defined in function of a cluster of color values that represents a dominant color of the object;
identify one or more shapes formed by one or more clusters of the found pixels;
for each identified shape, compare a color histogram of the pixels of the second image that belong to the identified shape to a color histogram of the pixels of the object for which the range of color values has been determined, and if the comparison results in a color histogram difference that is above a predefined threshold, then discarding the identified shape, otherwise identify and/or memorize the region in the second image where the shape, corresponding to the object to be detected and located, has been identified.

27. The computing system according to claim 26, wherein, for detecting the object in one or more regions in the second image, the computing system is configured to:
receive a third image that is a 2D pixel image of the physical environment acquired according to a same point of view as the second image, but at a different time T;
compare the second image with the third image in order to identify one or more areas wherein the second image and the third image are different;
discard areas whose size is smaller than a predefined area threshold, and, for each area whose size is greater than the predefined area threshold, identify and/or memorize the region in the second image where the area, which corresponds to the missing or newly present object to be detected and located, has been identified.

28. A non-transitory computer-readable medium encoded with executable instructions that, when executed, cause one or more data processing systems to:
acquire or receive a first image representing a physical environment, the first image being a 3D point cloud image with location data for points in the point cloud image;
acquire or receive a second image representing the physical environment, the second image being a 2D pixel image of the physical environment;
detect the object in one or more regions in the second image;
for each region where the object has been detected in the second image, find a corresponding region in the first image; and
provide, via an interface, the corresponding region in the first image as a location where the object has been detected.

29. The non-transitory computer-readable medium of claim 28, wherein for detecting the object in one or more regions in the second image, the executable instructions, when executed, cause the one or more data processing systems to:
find, in the second image, pixels whose color value falls within a range of color values defined as a function of a cluster of color values that represents a dominant color of the object;
identify one or more shapes formed by one or more groups or clusters of the found pixels;
for each identified shape, compare a color histogram of the pixels of the second image that belong to the identified shape with a color histogram of the pixels of the object for which the range of color values has been determined, and if the comparison results in a color histogram difference that is above a predefined threshold, then discarding the identified shape, otherwise identifying and/or memorizing the region in the second image where the shape, corresponding to the object to be detected and located, has been identified.

30. The non-transitory computer-readable medium according to claim 28, wherein for detecting the object in one or more regions in the second image, the executable instructions, when executed, cause the one or more data processing systems to:
receive a third image that is a 2D pixel image of the physical environment acquired according to a same point of view as the second image, but at a different time T;
compare the second image with the third image in order to identify one or more areas wherein the second image and the third image are different;
discard areas whose size is smaller than a predefined area threshold, and, for each area whose size is greater than the predefined area threshold, identifying and/or memorizing the region in the second image where the area, which corresponds to the missing or newly present object to be detected and located, has been identified.

31. The non-transitory computer-readable medium according to claim 30, wherein the region in the second image where the area corresponding to the missing or newly present object has been identified is identified and/or memorized by surrounding the concerned area by a bounding box.
